(19) United States
(12) Patent Application Publication
(10) Pub. No.: US 2011/0258206 A1
(43) Pub. Date: Oct. 20, 2011

(54) SYSTEM AND METHOD FOR EVALUATING MARKETER RE-IDENTIFICATION RISK

(75) Inventors: Khaled El Emam, Ottawa (CA); Fida Dankar, Ottawa (CA)

(73) Assignee: University of Ottawa, Ottawa (CA)

(21) Appl. No.: 13/052,497

(22) Filed: Mar. 21, 2011

Related U.S. Application Data
(60) Provisional application No. 61/315,739, filed on Mar. 19, 2010.

(51) Int. Cl. G06N 5/02; G06F 17/30

(52) U.S. Cl. 707/754; 706/52; 707/E17.044

(57) ABSTRACT

Disclosures of databases for secondary purposes is increasing rapidly and any identification of personal data may from a dataset of database can be detrimental. A re-identification risk metric is determined for the scenario where an intruder wishes to re-identify as many records as possible in a disclosed database, known as a marketer risk. The dataset can be analyzed to determine equivalence classes for variables in the dataset and one or more equivalence class sizes. The re-identification risk metric associated with the dataset can be determined using a modified log-linear model by measuring a goodness of fit measure generalized for each of the one or more equivalence class sizes.

### TECHNICAL FIELD

The present disclosure relates to databases and particularly to systems and methods to protecting privacy by de-identification of personal data stored in the databases.

### BACKGROUND

Personal information is being continuously captured in a multitude of electronic databases. Details about health, financial status and buying habits are stored in databases managed by public and private sector organizations. These databases contain information about millions of people, which can provide valuable research, epidemiologic and business insight. For example, examining a drugstore chain's prescriptions can indicate where a flu outbreak is occurring. To extract or maximize the value contained in these databases, data custodians must often provide outside organizations access to their data. In order to protect the privacy of the people whose data is being analyzed, a data custodian will “de-identify” information before releasing it to a third-party. An important type of de-identification ensures that data cannot be traced to the person about whom it pertains, this protects against ‘identity disclosure’.

When de-identifying records, many people assume that removing names and addresses (direct identifiers) is sufficient to protect the privacy of the persons whose data is being released. The problem of de-identification involves those personal details that are not obviously identifying. These personal details, known as quasi-identifiers, include the person's age, sex, postal code, profession, ethnic origin and income (to name a few).

Data de-identification is currently a manual process. Heuristics are used to make a best guess about how to remove identifying information prior to releasing data. Manual data de-identification has resulted in several cases where individuals have been re-identified in supposedly anonymous datasets. One popular anonymization approach is k-anonymity. There have been no evaluations of the actual re-identification probability of k-anonymized data sets and datasets are being released to the public without a full understanding of the vulnerability of the dataset.

Accordingly, systems and methods that enable improved risk identification and mitigation for data sets remain highly desirable.

### SUMMARY

Disclosures of databases for secondary purposes is increasing rapidly. A re-identification risk metric is provided for the case where an intruder wishes to re-identify as many records as possible in a disclosed database. In this case, the intruder is concerned about the overall matching success rate. The metric is evaluated on public and health datasets and recommendations for its use are provided.

In accordance with an aspect of the present disclosure there is provided a method of assessing re-identification risk of a dataset containing personal information, the method executed by a processor. The method comprising retrieving the dataset comprising a plurality of records from a storage device; receiving variables selected from a plurality of variables present in the dataset, wherein the variables may be used as potential identifiers of personal information from the dataset; and determining equivalence classes for each of the selected variables in the dataset and one or more equivalence class sizes; determining a re-identification risk metric associated with the dataset using a modified log-linear model by measuring a goodness of fit measure generalized for each of the one or more equivalence class sizes.

In accordance with another aspect of the present disclosure there is provided a system for assessing re-identification risk of a dataset containing personal information, the system comprising: a memory; a processor coupled to the memory, the processor performing: retrieving the dataset comprising a plurality of records from the memory; receiving variables selected from a plurality of variables present in the dataset, wherein the variables may be used as potential identifiers of personal information from the dataset; and determining equivalence classes for each of the selected variables in the dataset and one or more equivalence class sizes; determining a re-identification risk metric associated with the dataset using a modified log-linear model by measuring a goodness of fit measure generalized for each of the one or more equivalence class sizes.

In accordance with yet another aspect of the present disclosure there is provided a computer readable memory containing instructions for assessing re-identification risk of a dataset containing personal information, the instructions when executed by a processor performing: retrieving the dataset comprising a plurality of records from the memory; receiving variables selected from a plurality of variables present in the dataset, wherein the variables may be used as potential identifiers of personal information from the dataset; and determining equivalence classes for each of the selected variables in the dataset and one or more equivalence class sizes; determining a re-identification risk metric associated with the dataset using a modified log-linear model by measuring a goodness of fit measure generalized for each of the one or more equivalence class sizes.

### BRIEF DESCRIPTION OF THE DRAWINGS

Further features and advantages of the present disclosure will become apparent from the following detailed description, taken in combination with the appended drawings, in which:

FIG. 1 shows a representation of example dataset quasi-identifiers;

FIG. 2 shows a representation of dataset attack;

FIG. 3 shows a system for performing risk assessment;

FIG. 4 is an example of a prescription record database being disclosed containing patient demographics being matched against a population registry (identification database) which an intruder has access to. The prescription database is a sample of the population registry;

FIG. 5 shows a method for assessing re-identification risk and de-identification;

FIG. 6 shows an exemplary method of determining a re-identification risk using a modified log-linear model;

FIG. 7 shows variable selection;

FIG. 8 shows threshold selection;

FIG. 9 shows a result view after performing a risk assessment; and

FIG. 10a-d graphs showing the relative error for each of the four data sets.

It will be noted that throughout the appended drawings, like features are identified by like reference numerals.

### DETAILED DESCRIPTION

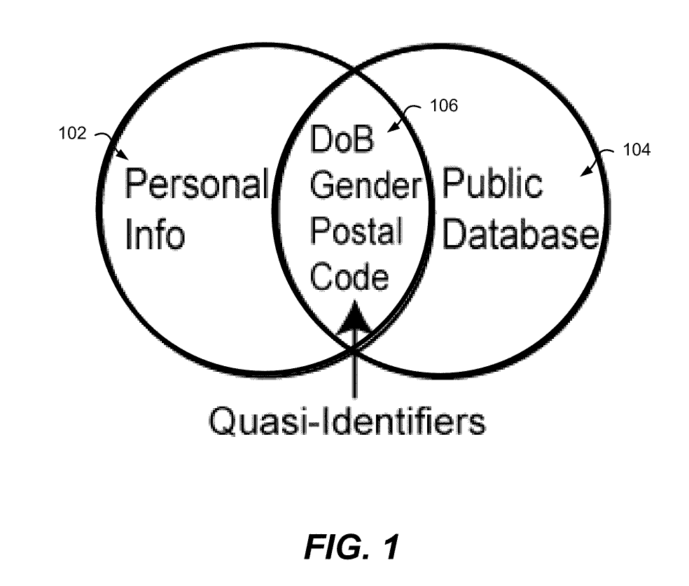

Embodiments are described below, by way of example only, with reference to FIGS. 1-10.

When datasets are released containing personal information, potential identification information is removed to minimize the possibility of re-identification of the information. However there is a fine balance between removing information that may potentially lead to identification of the personal data stored in the database versus the value of the database itself. A commonly used criterion for assessing re-identification risk is k-anonymity. With k-anonymity an original data set containing personal information can be transformed so that it is difficult for an intruder to determine the identity of the individuals in that data set. A k-anonymized data set has the property that each record is similar to at least another k−1 other records on the potentially identifying variables. For example, if k=5 and the potentially identifying variables are age and gender, then a k-anonymized data set has at least 5 records for each value combination of age and gender. The most common implementations of k-anonymity use transformation techniques such as generalization, and suppression.

Any record in a k-anonymized data set has a maximum probability 1/k of being re-identified. In practice, a data custodian would select a value of k commensurate with the re-identification probability they are willing to tolerate—a threshold risk. Higher values of k imply a lower probability of re-identification, but also more distortion to the data, and hence greater information loss due to k-anonymization. In general, excessive anonymization can make the disclosed data less useful to the recipients because some analysis becomes impossible or the analysis produces biased and incorrect results.

Ideally, the actual re-identification probability of a k-anonymized data set would be close to 1/k since that balances the data custodian's risk tolerance with the extent of distortion that is introduced due to k-anonymization. However, if the actual probability is much lower than 1/k then k-anonymity may be over-protective, and hence results in unnecessarily excessive distortions to the data.

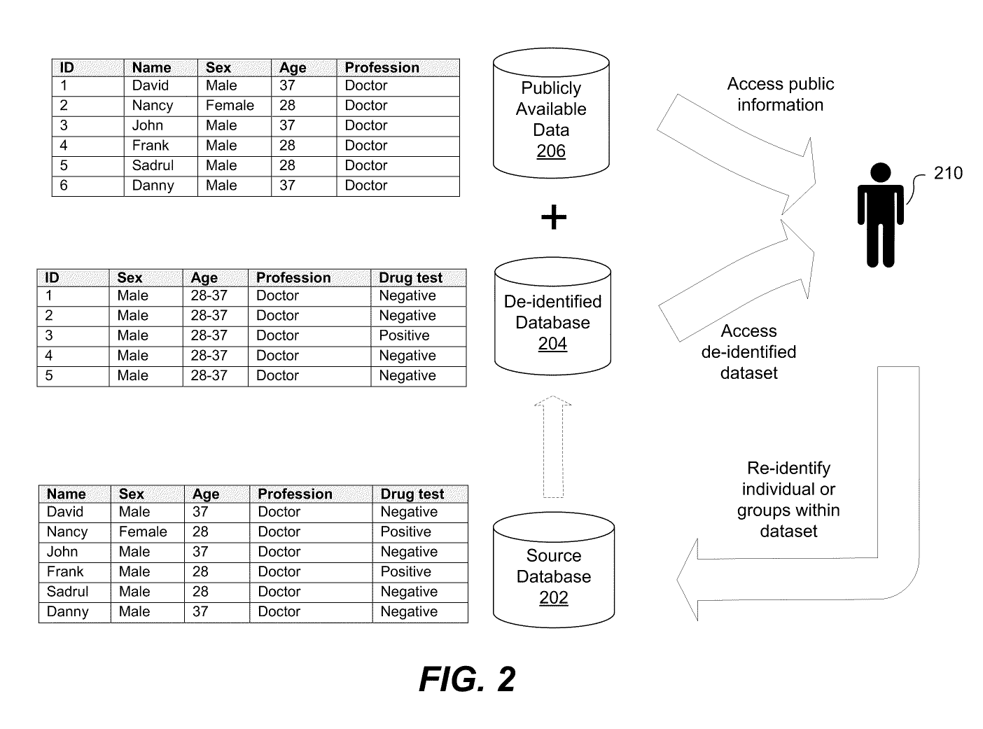

As shown in FIG. 1 re-identification can occur when personal information 102 related to quasi-identifiers 106 in a dataset, such as date of birth, gender, postal code can be referenced against public data 104. As shown in FIG. 2, source database or dataset 202 is de-identified using anonymization techniques such as k-anonymity, to produce a de-identified database or dataset 204 where potentially identifying information is removed or suppressed. Attackers 210 can then use publicly available data 206 to match records using quasi-identifiers present in the dataset re-identifying individuals in the source dataset 202. Anonymization and risk assessment can be performed to assess risk of re-identification by attack and perform further de-identification to reduce the probability of a successful attack.

A common attack is a ‘Marketer’ attack uses background information about a specific individual to re-identify them. If the specific individual is rare or unique then they would be easier to re-identify. For example, a 120 years-old male who lives in particular region would be at a higher risk of re-identification given his rareness. To measure the risk from a Marketer attack, the number of records that share the same quasi-identifiers (equivalence class) in the dataset is counted. Take the following dataset as an example:

| ID | Sex | Age | Profession | Drug test |
|---|---|---|---|---|
| 1 | Male | 37 | Doctor | Negative |
| 2 | Female | 28 | Doctor | Positive |
| 3 | Male | 37 | Doctor | Negative |
| 4 | Male | 28 | Doctor | Positive |
| 5 | Male | 28 | Doctor | Negative |
| 6 | Male | 37 | Doctor | Negative |

In this dataset there are three equivalence classes: 28 year-old male doctors (2), 37-year-old male doctors (3) and 28-year old female doctors (1).

If this dataset is exposed to a Marketer Attack, say an attacker is looking for David, a 37-year-old doctor, there are 3 doctors that match these quasi-identifiers so there is a ⅓ chance of re-identifying David's record. However, if an attacker were looking for Nancy, a 28-year-old female doctor, there would be a perfect match since only one record is in that equivalence class. The smallest equivalence class in a dataset will be the first point of a re-identification attack.

The number of records in the smallest equivalence class is known as the dataset's “k” value. The higher k value a dataset has, the less vulnerable it is to a Marketer Attack. When releasing data to the public, a k value of 5 is often used. To de-identify the example dataset to have a k value of 5, the female doctor would have to be removed and age generalized.

| ID | Sex | Age | Profession | Drug test |
|---|---|---|---|---|
| 1 | Male | 28-37 | Doctor | Negative |
| 3 | Male | 28-37 | Doctor | Negative |
| 4 | Male | 28-37 | Doctor | Positive |
| 5 | Male | 28-37 | Doctor | Negative |
| 6 | Male | 28-37 | Doctor | Negative |

As shown by this example, the higher the k-value the more information loss occurs during de-identification. The process of de-identifying data to meet a given k-value is known as “k-anonymity”. The use of k-anonymity to defend against a Marketer Attack has been extensively studied.

A Journalist Attack involves the use of an “identification database” to re-identify individuals in a de-identified dataset. An identification database contains both identifying and quasi-identifying variables. The records found in the de-identified dataset are a subset of the identification database (excluding the identifying variables). An example of an identification database would be a driver registry or a professional's membership list.

A Journalist Attack will attempt to match records in the identification database with those in a dataset. Using the previous Marketer Attack example:

| ID | Sex | Age | Profession | Drug test |
|---|---|---|---|---|
| 1 | Male | 37 | Doctor | Negative |
| 2 | Female | 28 | Doctor | Positive |
| 3 | Male | 37 | Doctor | Negative |
| 4 | Male | 28 | Doctor | Positive |
| 5 | Male | 28 | Doctor | Negative |
| 6 | Male | 37 | Doctor | Negative |

It was shown that the 28-year-old female doctor is at most risk of a Marketer Attack. This record can be matched using the following identification database.

| ID | Name | Sex | Age | Profession |
|---|---|---|---|---|
| 1 | David | Male | 37 | Doctor |
| 2 | Nancy | Female | 28 | Doctor |
| 3 | John | Male | 37 | Doctor |
| 4 | Frank | Male | 28 | Doctor |
| 5 | Sadrul | Male | 28 | Doctor |
| 6 | Danny | Male | 37 | Doctor |
| 7 | Jacky | Female | 28 | Doctor |
| 8 | Lucy | Female | 28 | Doctor |
| 9 | Kyla | Female | 28 | Doctor |
| 10 | Sonia | Female | 28 | Doctor |

Linking the 28-year-old female with the identification database will result in 5 possible matches (1 in 5 chance of re-identifying the record).

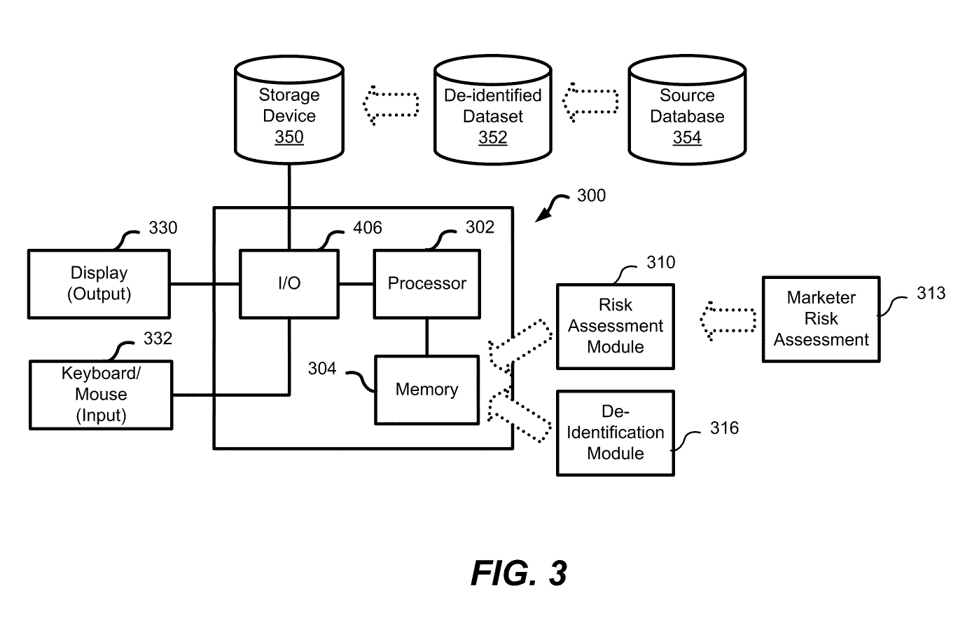

FIG. 3 shows a system for performing risk assessment of a de-identified dataset. The system 300 is executed on a computer comprising a processor 302, memory 304, and input/output interface 306. The memory 304 executes instructions for providing a risk assessment module 310 which performs an assessment of marketer risk 313. The risk assessment may also include a de-identification module 316 for performing further de-identification of the database or dataset based upon the assessed risk. A storage device 350, either connected directly to the system 300 or accessed through a network (not shown) stored the de-identified dataset 352 and possibly the source database 354 (from which the dataset is derived) if de-identification is being performed by the system. A display device 330 allows the user to access data and execute the risk assessment process. Input devices such as keyboard and/or mouse provide user input to the I/O module 306. The user input enables selection of desired parameters utilized in performing risk assessment. The instructions for performing the risk assessment may be provided on a computer readable memory. The computer readable memory may be external or internal to the system 300 and provided by any type of memory such as read-only memory (ROM) or random access memory (RAM). The databases may be provided by a storage device such compact disc (CD), digital versatile disc (DVD), non-volatile storage such as a harddrive, USB flash memory or external networked storage.

As more ostensibly de-identified health data sets are disclosed for secondary purposes, it is becoming important to measure the risk of patient re-identification (i.e., identity disclosure) objectively, and manage that risk. Previous risk measures focused mostly on the case where a single patient is being re-identified. With these previous measures, the patient with the highest re-identification risk represented the risk for the whole data set.

In practice, an intruder may re-identify more than one patient. The potential harm to the patients and the custodian would be much higher if many patients are re-identified as opposed to a single one. Therefore, there will be scenarios where the data custodian is interested in assessing the number of records that could be correctly re-identified. There is a dearth of generally accepted re-identification risk measures for the case where an intruder attempts to re-identify all patients (or as many patients as possible) in a data set.

The variables that can potentially re-identify patient records in a disclosed data set are called the quasi-identifiers (qids). Examples of common quasi-identifiers are: dates (such as, birth, death, admission, discharge, visit, and specimen collection), race, ethnicity, languages spoken, aboriginal status, and gender. An intruder would attempt to re-identify all patients in a disclosed data set by matching against an identification database. An identification database would contain the qids as well as directly identifying information about the patients (e.g., their names and full addresses). There are two scenarios where this could plausibly occur.

### Public Registries

In the US it is possible to obtain voter lists for free or for a modest fee in most states. A voter list contains voter names and addresses, as well as their basic demographics, such as their date of birth, and gender. Some states also include race and political affiliation information. A voter list is a good example of an identification database.

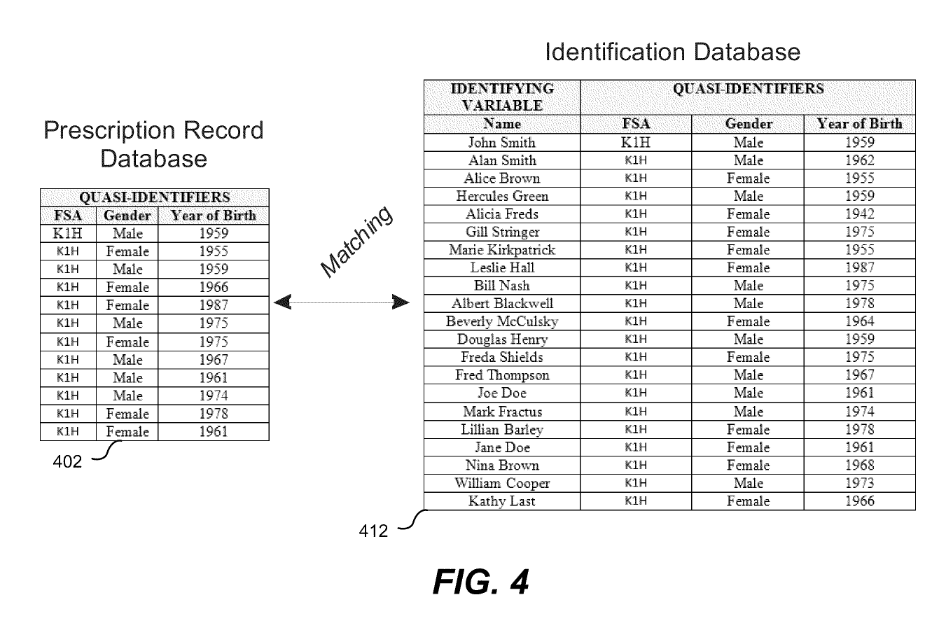

Consider the example in FIG. 4 of prescription records 402. Retail pharmacies in the US and Canada sell these records to commercial data brokers. These records include the basic patient demographics. An intruder can obtain an identification database 412 such as a voter list for the specific county where a pharmacy resides and match with the prescription records to potentially re-identify many patients. In Canada voter lists are not (legally) readily available. However, other public registries exist which contain the basic demographics on large segments of the population, and can serve as suitable identification databases.

### Marketer Risk

In this disclosure, a re-identification risk metric is disclosed for the case where an intruder wishes to re-identify as many records as possible in the disclosed database. It is assumed that the intruder lacks any additional information apart from the matching quasi-identifiers.

The intruder is not interested in knowing which records from the disclosed data set were re-identified. Instead, the important metric is the proportion of records in the disclosed data set that are correctly re-identified.

The (expected) proportion of records that are correctly re-identified are called the marketer risk metric. This term is used to represent the archetypical scenario where the intruder is matching the two databases for the purposes of marketing to the individuals in the disclosed database.

There are two cases where marketer risk needs to be computed. The first is when the disclosed database has the same individuals as the identification database. The second is when the disclosed database is a subset/sample from the identification database (as in the example of FIG. 4). While the second case is most likely to occur in practice, there are no appropriate metrics for it in the literature.

Below, a marketer risk metric is formulated for both of the above cases.

The set of the records in the disclosed patient database is denoted as U and the set of records in the identification database as D, and U⊂D. Let |U|=n, and |D|=N, which gives the total number of records in each database.

Each record pertains to a unique patient. The set of qids is denoted by Z={z₁, . . . , zₚ}, and let |zᵢ| be the number of unique values that the specific qid, zᵢ, takes in the actual data set.

The discrete variable formed by cross-classifying all possible values on the qids is denoted by X, with the values denoted by 1, . . . , J. Each of these values corresponds to a possible combination of values of the qids (note that

$${\prod }_{i = 1}^{p} \vert {z}_{i} \vert = J ) .$$

The records with the value jε{1, . . . , J} is called an equivalence class. For example, all records in a data set about 17 year old males admitted on 1 Jan. 2008 are an equivalence class.

In practice, however, not all possible equivalence classes may appear in the data set. Therefore it is denoted by \tilde{J} as the number of actual different values that appear in the data. Let Xᵢ denote the value of X for patient i. The frequencies for different values of \tilde{J} are given by

$${F}_{j} = {\sum }_{i ∈ D} I ( {X}_{i} = j ) ,$$

where jε{1, . . . , \tilde{J}} and I(•) is the indicator function. Similarly,

$${f}_{j} = {\sum }_{i ∈ U} I ( {X}_{i} = j )$$

where jε{1, . . . , \tilde{J}} is defined.

The set of records in an equivalence class in U by gⱼ are defined, and the set of records in an equivalence class in D by Gⱼ. This also means that |gⱼ|=ƒⱼ and |Gⱼ|=Fⱼ for jε{1, . . . , \tilde{J}}.

### Measuring Re-Identification Risk

An intruder tries to match the two databases one equivalence class at a time. In other words, for every jε{1, . . . , \tilde{J}}, the intruder matches the records in gⱼ to the records in Gⱼ. Lacking any additional information apart from the matching qids, the intruder can match any two records from the two corresponding equivalence classes at random with equal probability. The intruder has the option to consider one-to-one mappings (i.e., no two records in gⱼ can be mapped to the same record in Gⱼ) or not. In what follows, it is proven that both cases (i.e., when considering only one-to-one mappings or not) the expected number of records that can be correctly matched is ƒⱼ/Fⱼ per equivalence class, and the expected proportion of records that can be re-identified from the disclosed database is

$$\frac{1}{n} \times {\sum }_{j = 1}^{\tilde{J}} \frac{{f}_{j}}{{F}_{j}} .$$

The expected proportion of U records that can be disclosed in a random mapping from U to D is.

$$λ = {\sum }_{j = 1}^{\tilde{J}} \frac{{f}_{j} / {F}_{j}}{n} \qquad ( 1 )$$

Note that if n=N then

$$λ = \frac{\tilde{J}}{N} .$$

Two cases are considered, the first case is when only one to one random mappings are used, and the second case is when any random mapping is used.

### A. One to One Mappings:

First prove that the expected number of records that can be re-identified from any equivalence class gⱼ is

$$\frac{{f}_{j}}{{F}_{j}} :$$

Assume that m records in gⱼ have been matched to m different records in Gⱼ for some mε{1, . . . , ƒᵢ−1}, then the probability that the m+1^{th} record in gⱼ (which is denoted by r) will be correctly matched to its corresponding record in Gⱼ (the corresponding match is denoted by S), or Pᵣₛ can be calculated as follows:

Pᵣₛ=P(record S is not matched to any of the previously matched m records)P(r is assigned to s)

$$\begin{matrix}= \frac{( \begin{matrix}{F}_{j} - 1 \\ m\end{matrix} )}{( \begin{matrix}{F}_{j} \\ m\end{matrix} )} \frac{1}{{F}_{j} - m} \\ = \frac{{F}_{j} - m}{{F}_{j}} \frac{1}{{F}_{j} - m} \\ = \frac{1}{{F}_{j}}\end{matrix}$$

Hence the expected number of records that would be disclosed from any equivalence class gⱼ is

$${\sum }_{1}^{{f}_{j}} \frac{1}{{F}_{j}} = \frac{{f}_{j}}{{F}_{j}} .$$

Now, the expected total number of records correctly matched becomes:

$${\sum }_{j = 1}^{\tilde{J}} {f}_{j} / {F}_{j} ,$$

and the proportion of records correctly matched is

$${\sum }_{j = 1}^{\tilde{J}} \frac{{f}_{j} / {F}_{j}}{n} .$$

### B. Random Mappings:

First that the expected number of records that can be disclosed from any equivalence class gⱼ is

$$\frac{{f}_{j}}{{F}_{j}}$$

determined:
Let a be any record in gⱼ, the probability that a is correctly matched in a random mapping from gⱼ to Gⱼ is

$$\frac{1}{{F}_{j}}$$

(because a could be matched to any record in Fⱼ)

Now the expected number of records that would be disclosed from any equivalence class gⱼ is

$${\sum }_{1}^{{f}_{j}} \frac{1}{{F}_{j}} = \frac{{f}_{j}}{{F}_{j}}$$

Hence the proportion of records that can be disclosed is again

$${\sum }_{j = 1}^{\tilde{J}} \frac{{f}_{j} / {F}_{j}}{n} .$$

In a publication by Domingo-Ferrer and V. Torra, entitled “Disclosure risk assessment in statistical microdata protection via advanced record linkage,” published in Statistics and Computing, vol. 13, 2003, hereinafter referred to as Domingo-Ferrer et al., the matching problem is considered from the record linkage perspective. Domingo-Ferrer et al. discuss the case where the linking procedure for the records in gⱼ and Gⱼ is random (in other words, they assume that the intruder has no background information), they only consider one to one mappings from gⱼ to Gⱼ, and they only consider the case where n=N, i.e. when ƒⱼ=Fⱼ for all j. In that context, they prove that the probability of re-identifying exactly R individuals from Gⱼ is:

$${\sum }_{v = 0}^{{F}_{j} - R} \frac{{( - 1 )}^{v} / v !}{R !} .$$

The expected number of re-identified records from an equivalence class Gⱼ is then:

$${\sum }_{R = 0}^{{F}_{j}} R {\sum }_{v = 0}^{{F}_{j} - R} \frac{\frac{{( - 1 )}^{v}}{v !}}{R !}$$

which, turns out to be equal to 1. Hence, the expected total proportion of records re-identified in the identification database is equal to

$$\frac{\tilde{J}}{N} .$$

In another publication by T. M. Truta, F. Fotouhi, and D. Barth-Jones, entitled “Assessing global disclosure risk in masked microdata,” in Proceedings of the Workshop on Privacy and Electronic Society (WPES2004), in conjunction with 11th ACM CCS, 2004, pp. 85-93, hereinafter referred to as Truta et al., a measure of disclosure risk is presented that considers the distribution of the non-unique records in the sample. The measure represents the record linkage success probability for all records in the sample. The measure is the same as ours:

$${\sum }_{j = 1}^{\tilde{J}} \frac{{f}_{j} / {F}_{j}}{n} ,$$

and was presented as a generalization of the sample and population uniqueness measure:

$${\sum }_{j ; {F}_{j} = 1} \frac{{f}_{j}}{n} .$$

In the case where the disclosed database is a sample of the identification database as illustrated in FIG. 4 (i.e., U⊂D), the data custodian often does not have access to an identification database to compute the marketer risk before disclosing the data. For example, a pharmacy chain that is selling its prescription records will not purchase all voter lists across the states it operates in to create a population identification database to determine whether the marketer risk is too high or not. Furthermore, identification databases using public registries can be very costly to create in practice.

In such a case, an estimate of the marketer risk, \hat{λ} is required. The values of ƒⱼ would be known to the data custodian, therefore an estimate of the values 1/Fⱼ using only the information in the disclosed database.

### Estimators

Three estimators can be used to operationalize the marketer risk metric when only a sample is being disclosed: the Argus estimator, the Poisson log-linear mode, and the negative binomial model.

Recall that N denotes the total population number, and n the size of the sample. Denote by pⱼ the probability that a member of the class Gⱼ is sampled (i.e., belongs to gⱼ), and by γⱼ the probability that a member of the population belongs to the equivalence class Gⱼ.

### Argus

Mu-Argus proposes a model where Fⱼ|ƒⱼ is a random variable with a negative binomial distribution, where ƒⱼ is the number of successes with the probability of a success being pⱼ:

$$P ( {F}_{j} = h \vert {f}_{j} ) = ( \begin{matrix}h - 1 \\ {f}_{j} - 1\end{matrix} ) {{p}_{j}^{{f}_{j}} ( 1 - {p}_{j} )}^{h - {f}_{j}}$$

$$h \geq {f}_{j} > 0$$

With the above assumptions, the expected value of 1/Fⱼ is given by:

$$E ( \frac{1}{{F}_{j}} \vert {f}_{j} ) = {\sum }_{i = {f}_{j}}^{∞} \frac{1}{i} Pr ( {F}_{j} = i \vert {f}_{j} ) \qquad ( 2 )$$

Equation (2) can be calculated using the moment generation function M_{F}_{ⱼ}_{|ƒ}_{ⱼ} as follows:

$$E ( \frac{1}{{F}_{j}} \vert {f}_{j} ) = {\int }_{0}^{∞} {M}_{{F}_{j} \vert {f}_{j}} ( - t ) d t = {\int }_{0}^{∞} {\{ \frac{{p}_{j} {e}^{- t}}{1 - ( 1 - {p}_{j} ) {e}^{- t}} \}}^{{f}_{j}} d t$$

To estimate E(1/Fⱼ), first an estimate pⱼ is needed. Each record i in the sample is assumed to have a weighting factor wᵢ (also known as inflation factor) which represents the number of units in the population similar to unit i. As a first estimate, the following may be appropriate:

$${{p}^{⋒}}_{j} = \frac{{f}_{j}}{{{F}^{⋒}}_{j}^{D}} where {{F}^{⋒}}_{j}^{D} = {\sum }_{i ; j ( i ) = j} {w}_{i}$$

is the initial estimate for the population, where j(i)=j indicates that record i belongs to gⱼ.

Since the weight factors wᵢ are unknown, it may be appropriate to assume that pⱼ is constant across all equivalence classes and that

$${p}_{j} = \frac{n}{N} .$$

Note that the estimated value for Fⱼ depends only on ƒⱼ and is independent of the sample frequency in the other classes (i.e., there is no learning from other cells). Hence the information that one gains from the frequencies in neighboring cells is not used. However Argus has the advantage of being monotonic and simple to calculate.

In the Poisson log-linear model, the Fⱼ's are realizations of independent Poisson random variables with mean Nγⱼ:Fⱼ|γⱼ˜Poisson(Nγⱼ). Assuming that the sample is drawn by Bernoulli sampling with probability pⱼ, obtain:

$$P ( {F}_{j} = h \vert {f}_{j} ) = \frac{1}{( h - {f}_{j} ) !} {( N {γ}_{j} ( 1 - {p}_{j} ) )}^{h - {f}_{j}} {e}^{- N {γ}_{j} ( 1 - {p}_{j} )}$$

### Hence

$${E}_{{p}_{j}} ( \frac{1}{{F}_{j}} \vert {f}_{j} )$$

depends h≧ƒⱼ>0 on ƒⱼ, γⱼ and pⱼ. Which can be calculated using the moment generation function M_{F}_{ⱼ}_{|ƒ}_{ⱼ} as follows:

$${E}_{{p}_{j}} ( \frac{1}{{F}_{j}} \vert {f}_{j} ) = {\int }_{0}^{∞} {e}^{- {tf}_{j}} {e}^{N {γ}_{j} ( 1 - {p}_{j} ) ( {e}^{- t} - 1 )} d t .$$

Usually, a simple random sampling design is assumed where n=pⱼN. To estimate the parameters γⱼ, a log-linear model may be used. Log linear modeling consists of fitting models to the observed frequency (ƒⱼ) in the sample. The goodness of fit of the observed frequencies to the expected frequencies (uⱼ) is then computed. The estimate for γⱼ is then set to

$$\frac{{u}_{j}}{{p}_{j}} .$$

The log linear modeling approach uses data from neighborhood cells to determine the risk in a given cell (i.e., the estimated value of Fⱼ does not depend only on ƒⱼ), the extent of this dependence is a function of the log-linear model used.

It has been shown through empirical work that for large and sparse data, no known standard approach for model assessment works. The goodness of fit criterion was designed to detect underfitting (overestimation). Knowing that the independence model may lead to overestimation, and that overestimation decreases as more and more dependencies added, a forward search algorithm was used:

However, the known approach is based on fitting the equivalence classes in the sample that are of size 1 (i.e., for ƒⱼ=1), as the risk they are mainly interested in is the risk due to sample uniques.

The goodness of fit measure previously developed shows the impact of underfitting that is due to model misspecification. In other words, it represents the bias arising from the difference between the estimated γⱼ, say \hat{λ}ⱼ, and the actual γⱼ as follows:

$${B}_{1} = {\sum }_{j} E ( I ( {f}_{j} = 1 ) ) [ h ( {{γ}^{⋒}}_{j} ) - h ( {γ}_{j} ) ]$$

where h(γⱼ) is the disclosure risk due to uniques in the sample:

$$h ( {γ}_{j} ) = {\sum }_{{f}_{j} = 1} \frac{1 / {F}_{j}}{N} .$$

Since the risk measure entails the risk due to any equivalence class size, the previously developed goodness of fit measure is generalized to any fixed equivalence class size. In the present disclosure, the goodness of fit measure is also generalized to cover all equivalence class sizes as described below.

For every equivalence class size in the sample, say s, a search for the log-linear model that presents a good fit for these equivalence classes using an iterative method is performed. Once a good fit is found, the portion of the risk is computed that is due to the equivalence classes of size s, i.e.

$${\sum }_{{f}_{j} = s} \frac{s / {F}_{j}}{N} .$$

The procedure is repeated, fitting different log-linear models for every equivalence class size until all class sizes present in the sample is covered, at which time the overall risk would have been calculated. The goodness of fit measure used for the different equivalence class sizes is a generalization of the uniques goodness of fit B₁:
If hₖ denotes the disclosure risk due to equivalence class of size k, in other words

$${h}^{k} ( {γ}_{j} ) = {\sum }_{{f}_{j} = k} ( \frac{k / {F}_{j}}{N} ) ,$$

then to measure the model misspecification in equivalence classes of size k using:

$${B}_{k} = {\sum }_{j} E ( I ( {f}_{j} = k ) ) [ {h}^{k} ( {{y}^{⋒}}_{j} ) - {h}^{k} ( {γ}_{j} ) ] .$$

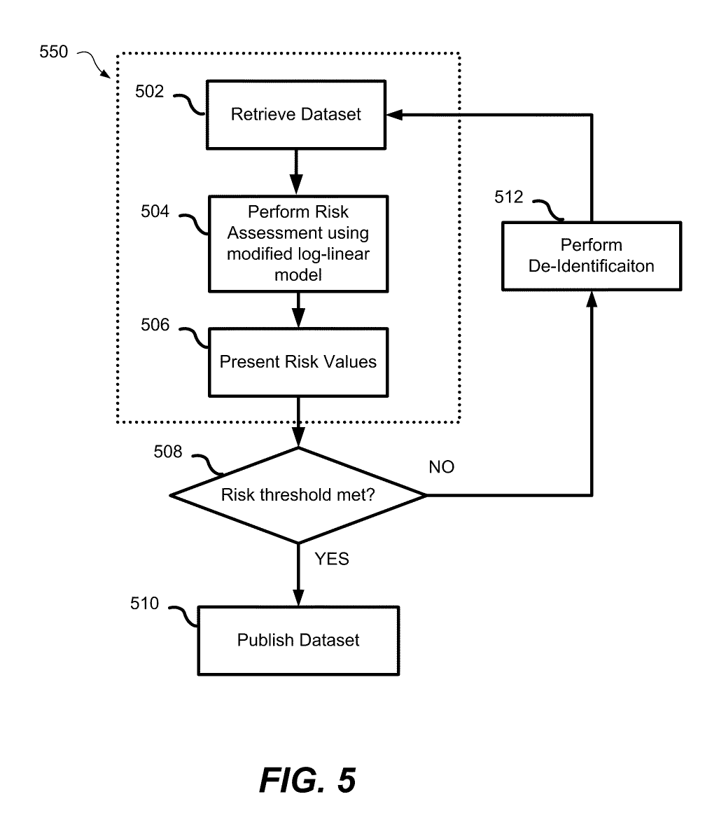

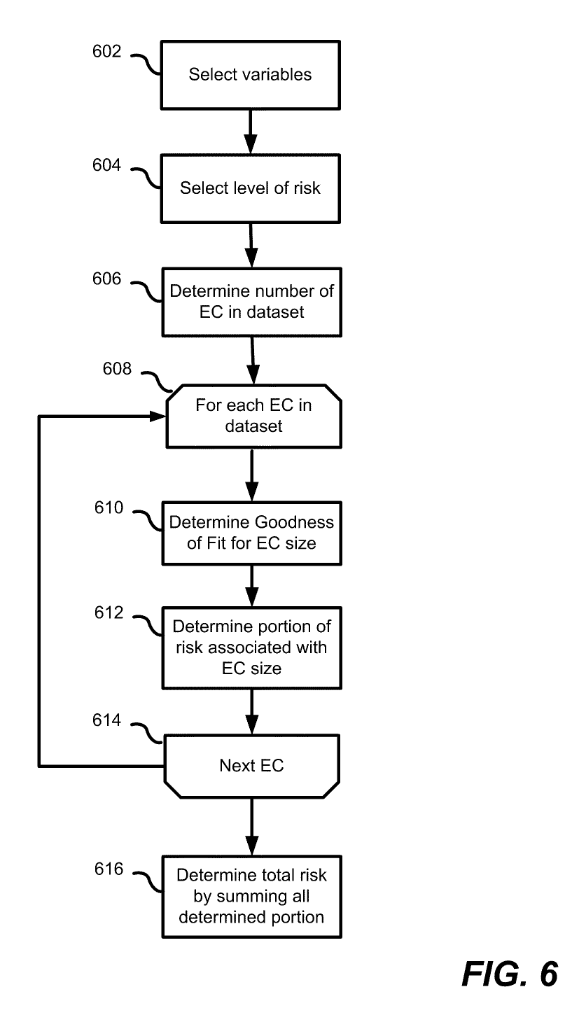

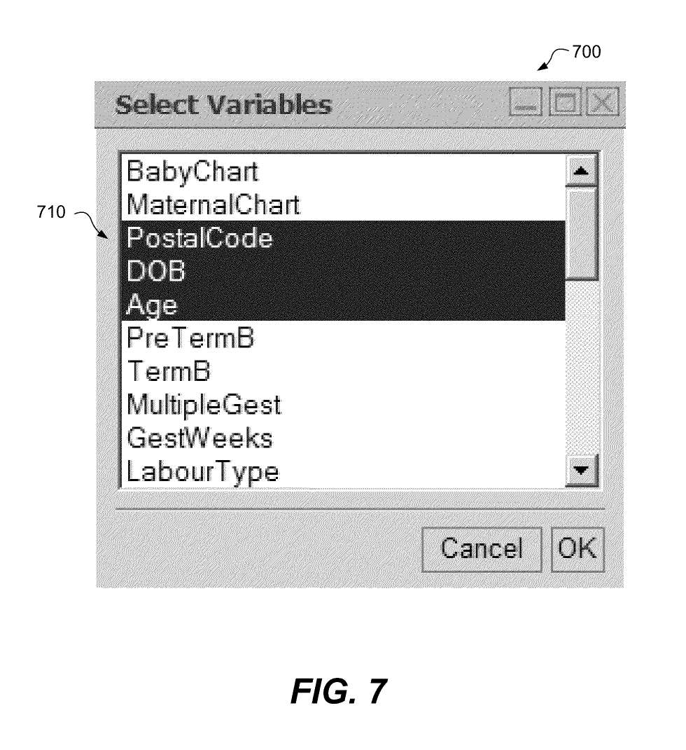

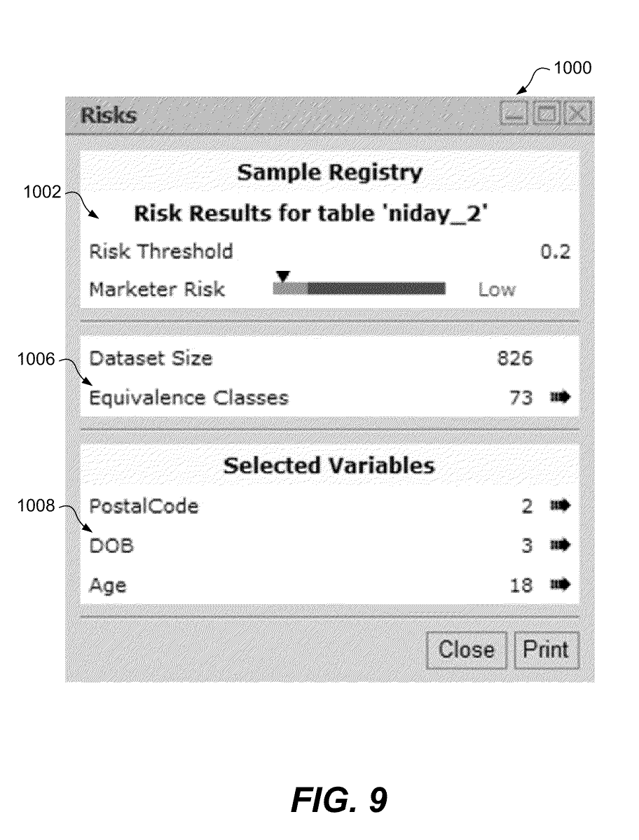

FIG. 5 shows a method of performing risk assessment and dataset de-identification as performed by system 300. The dataset is retrieved (502) either from local or remote memory such as the storage device 350. Risk assessment is performed (504) using a modified log-linear model as described below to determine a risk metric. An exemplary implementation is illustrated in FIG. 6 and described below. The assessed risk values can be presented (506) to the user as for example shown in FIG. 9. If the determined risk metric does not exceed that selected risk threshold, (YES at 508), the de-identified database can be published (510) as it meets the determined risk threshold. If the threshold is exceeded, (NO at 508), the dataset can be de-identified at (512) using anonymization techniques such as Optimal Lattice Anonymization or manual selection of data to be generalized or removed form the dataset until the desired risk threshold is achieved. If de-identification is not performed by the system, the risk assessment method (550) can be performed independently of the de-identification process. Note that the method may be iteratively performed to determine optimal and number equivalences classes for each variable to meet the desired risk threshold to remove acceptable identification information while attempting to minimize data loss in relation to the overall value of the database. In such an implementation the determining if the risk threshold has been met may further include automatically adjusting the number of equivalence classes in the dataset.

Now referring to FIG. 6, a risk assessment method using an exemplary modified log-linear model is described. At (602), the variables in the dataset to be disclosed that are at risk of re-identification are received as input from the user during execution of the application. The user may select variables present in the database such as shown in FIG. 7, where a window 700 provides a list of variables 710 which as selected for assessment. The variables may alternatively be automatically determined by the system or defined as default values. Examples of potentially risky variables include dates of birth, location information and profession.

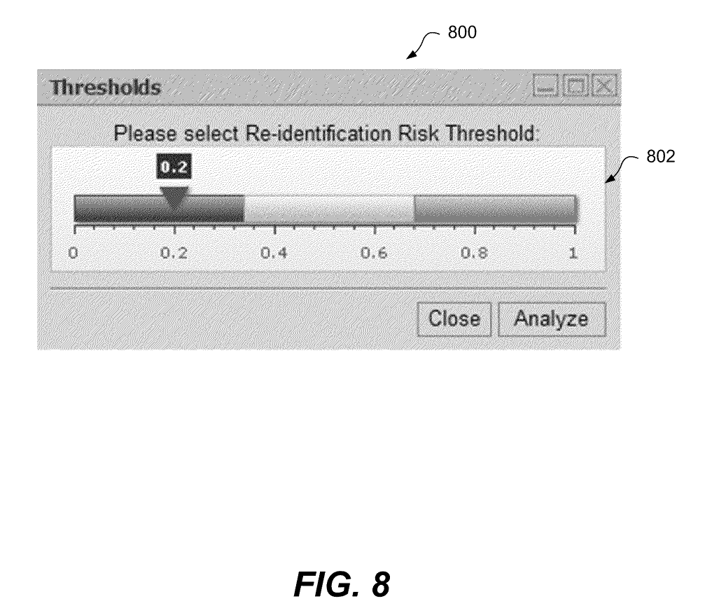

At 604, the user selects the acceptable risk threshold which is received by the system 300, for example through an input window 800 as shown in FIG. 8. The risk threshold 802 measures the chance of re-identifying a record. For example, a risk threshold of 0.2 indicates that there is a 1 in 5 chance of re-identifying a record

At 606, the number of equivalent classes for each of the selected variable is determined. For example, where ƒⱼε{3, 10, 15, 20}, the number of equivalent classes would be 4 (i.e. n=4) with sizes k=3, 10, 15 and 20.

Next, the system 300 iterates through each size in the equivalent classes (608 to 614). In each iteration, a goodness of fit measure (i.e. Bₖ as discussed above) and the portion of the risk associated with the equivalence class size (i.e. h^{k} as discussed above) are determined (610 and 612). After the system 300 iterates through all the equivalent class sizes, each portion of the risk calculated at (612) are summed together to determine the total risk metric (616). This total risk metric represents the risk associated with the dataset as retrieved (502) in FIG. 5, which is then presented to the system 300 (504) and checked against the selected risk threshold (508) in FIG. 5.

### Negative Binomial Model

In this model, a prior distrubution for γⱼ may be assumed: γⱼ˜Gamma(αⱼ,βⱼ) The population cell frequencies Fⱼ are independent Poisson random variables with mean Nγⱼ:Fⱼ|γⱼ=Poisson(Nγⱼ).

It is often assumed that α is constant with αβ=1/\tilde{J}, thus ensuring that E(Σγⱼ=1),

In the publication to J. Bethlehem, W. Keller, and J. Pannekoek, entitled “Disclosure control of microdata,” in the Journal of the American Statistical Association, vol. 85, pp. 38-45, 1990, hereinafter referred to as Bethlehem et al, considered only the case of sampling with equal probabilities, n=\hat{p}ⱼN Under these assumptions:

$$P ( {F}_{j} = h \vert {f}_{j} ) = ( \begin{matrix}α + h - 1 \\ h - {f}_{j}\end{matrix} ) {( \frac{{Np}_{j} + 1 / β}{N + 1 / β} )}^{α + {f}_{j}} {( \frac{N ( 1 - {p}_{j} )}{N + 1 / β} )}^{h - {f}_{j}}$$

The expected value of 1/Fⱼ h≧ƒⱼ>0 can be calculated from the above equation using the moment generation function M_{F}_{ⱼ}_{|ƒ}_{ⱼ} as follows:

$$E ( \frac{1}{{F}_{j}} \vert {f}_{j} ) = {\int }_{0}^{∞} {M}_{{F}_{j} \vert {f}_{j}} ( - t ) d t = {\int }_{0}^{∞} {e}^{- {tf}_{j}} {p}^{α + {f}_{j}} {\{ 1 - ( 1 - p ) {e}^{- t} \}}^{- α - {f}_{j}} d t$$

Notice that the expected value of 1/Fⱼ depends on α.

An estimate for α is obtained, which includes estimating the variance for ƒⱼ and the fact that αβ=1/\tilde{J}.

One of the difficulties of this model is the need to define the number of cells \tilde{J} in the population table. But since in most cases the population is not known, a known estimator is used to estimate the number of classes J in the population.

### Empirical Comparison of Estimators

A comparison of the performance of the resulting \hat{λ} marketer risk estimate relative to the actual marketer risk value for the three methods described above for estimating the 1/Fⱼ term in equation is presented. A simulation study was performed to evaluate \hat{λ} using each of the three population estimators relative to the actual λ.

TABLE 1

| Data Set | Quasi-identifiers | λ |
|---|---|---|
| FARS: fatal crash information database | Year (21) | 0.229 |
| from the department of transportation; | Age (99) | |
| n = 27,529 | Race (19) | |
| | Drinking Level (4) | |
| Adult (US Census); n = 30,162 | Age (72) | 0.104 |
| | Education (16) | |
| | Race (5) | |
| | Gender (2) | |
| Emergency department at children's | Postal Code—2 chars | 0.033 |
| hospital (6 months); n = 25,470 | (105) | |
| | Age (42) | |
| | Gender (2) | |
| Niday (provincial birth registry); | Postal Code—3 chars | 0.687 |
| n = 57,679 | (678) | |
| | Date of Birth—mth/yr (7) | |
| | Maternal Age (42) | |
| | Gender (2) | |
| Hospital pharmacy | | |

The five data sets used in the analysis are summarized in Table 1. Each data set is treated as the population and two thousands five hundreds random samples were drawn from it at five different sampling fractions (0.1 to 0.9 in increments of 0.2). For each sample an actual and estimated marketer risk and computed the relative error is computed:

$$RE = \frac{\hat{λ} - λ}{λ} \qquad ( 3 )$$

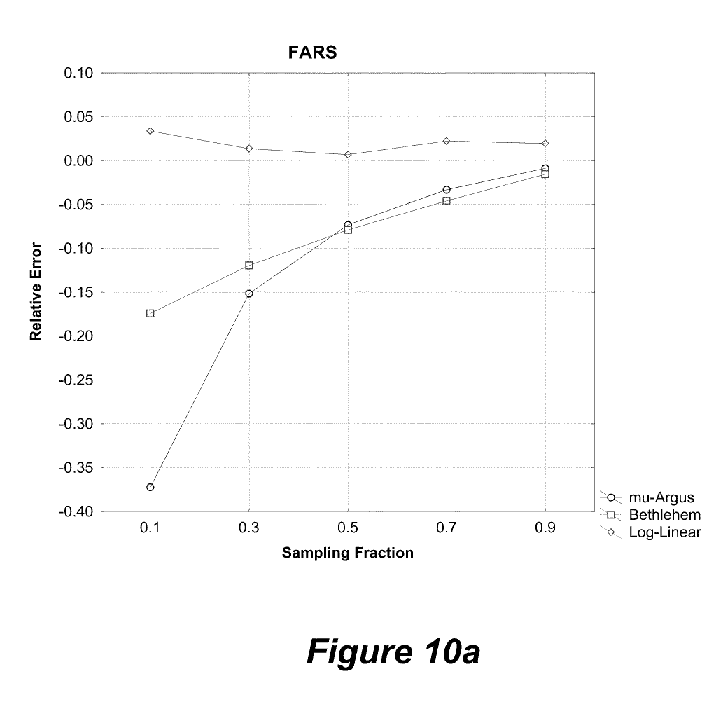

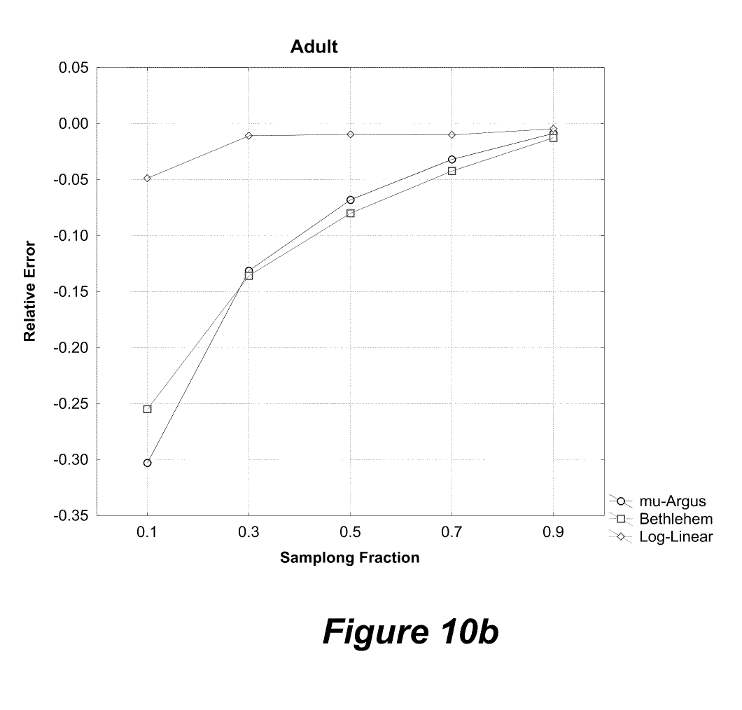

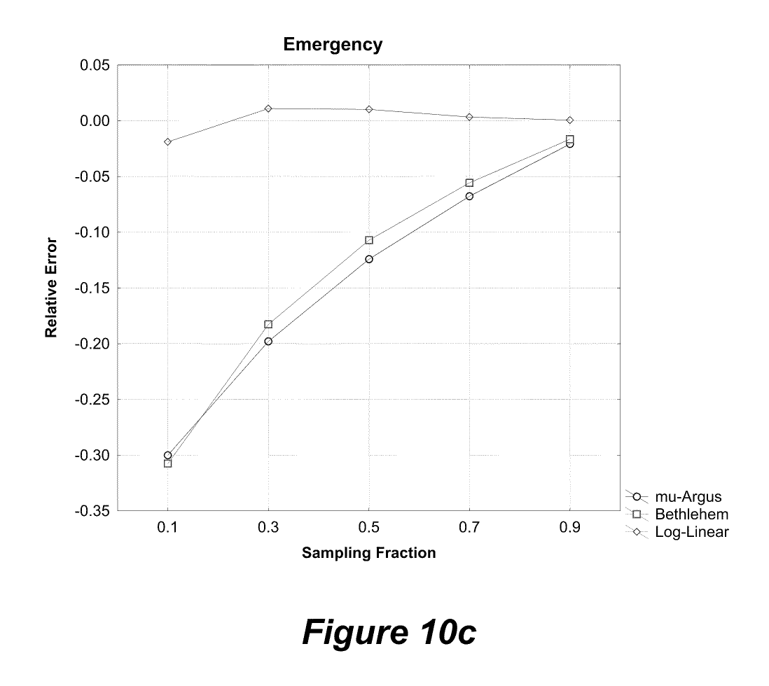

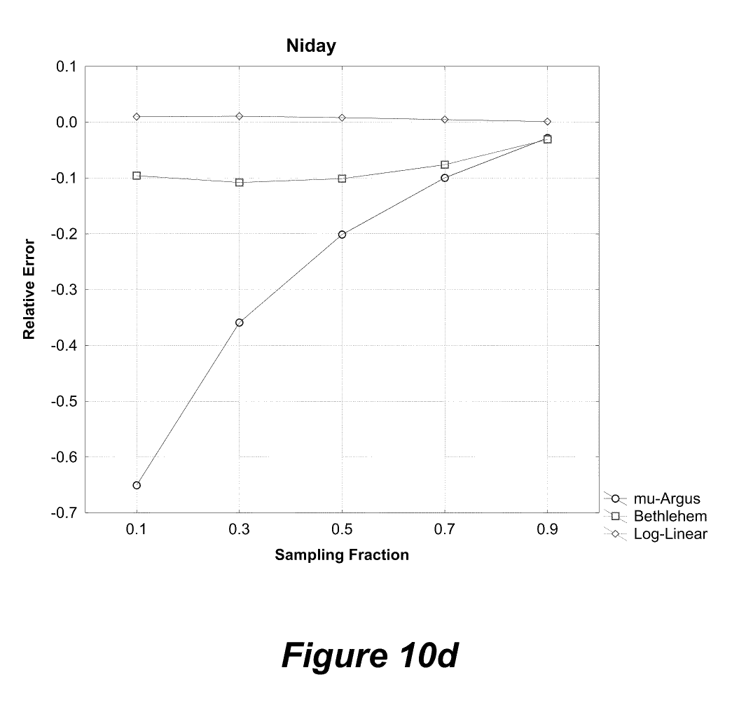

The mean relative error was computed across all of the samples. The results for the FARS, Adult, Emergency and Niday data sets in terms of the relative error (equation 3) are shown in FIGS. 10a-5d for the three estimators. As can be seen, the log-linear modeling approach has a significantly lower relative error than mu-Argus and the Bethlehem estimators as shown and demonstrated above. This appears to be the case across all sampling fractions and data sets.

### Application of the Marketer Risk Measure

An important question is how does a data custodian decide when is the expected proportion of records that would be correctly re-identified too high. Previous disclosures of cancer registry data have deemed thresholds of 5% and 20% of high risk records as acceptable for public release and research use respectively. These can be used as a basis for setting acceptability thresholds for marketer risk values.

Relationship to Other Risk Measures

Two other risk measures for identity disclosure have been defined. The first is Marketer risk, which is applicable when U=D, and is computed as:

$${R}_{p} = 1 / {min}_{j} ( {f}_{j} ) .$$

The second is journalist risk, which is applicable when U⊂D, and is computed as:

$${R}_{J} = \frac{1}{{min}_{j} ( {F}_{j} )} .$$

In both of these cases the risk measure captures the worse case probability of re-identifying a single record, whereas for marketer risk evaluating the expected number of records that would be correctly re-identified is performed. Another important difference is that marketer risk does not help identify which records in U are likely to be re-identified. However, with Journalist and Marketer risk measures it is possible to identify the highest risk records and focus disclosure control action only on those.

### Controlling Marketer Risk

Currently there are no known algorithms specifically designed to control marketer risk. However, an existing k-anonymity algorithms to control marketer risk can be used.

Assume that an intruder wishes to ensure that marketer risk is below some threshold, say τ. Then

$$\frac{1}{n} {\sum }_{j} \frac{{f}_{j}}{{F}_{j}} \leq ( \frac{1}{{min}_{j} ( {F}_{j} )} \cdot \frac{{\sum }_{j} {f}_{j}}{n} ) = \frac{1}{{min}_{j} ( {F}_{j} )} \qquad ( 4 )$$

Therefore, by ensuring that R_{J}≦τ it can also ensure that the marketer risk is below that threshold. Any k-anonymity algorithm can be used to guarantee that inequality.

A disadvantage of using k-anonymity algorithms is that they may cause more de-identification than necessary. The marketer risk value can be quite a bit smaller than R_{J} in practice. For example, consider a population data set with 3 equivalence classes Fⱼε{5, 20, 23} and the sample consisting of uniques. In this case the marketer risk value would be half the R_{J} value.

### When to Use Marketer Risk

If an intruder has an identification database, he can use it for re-identifying a single individual or for re-identifying as many individuals as possible. In the former case either the Marketer or Journalist risk metrics should be used, and in the latter case the marketer risk metric should be used. Therefore, the selection of a risk measure will depend on the motive of the intruder. While discerning motive is difficult, there will be scenarios where it is clear that marketer risk is applicable and represents the primary risk to be assessed and managed.

One scenario involves an intruder who is motivated to market a product to all of the individuals in the disclosed database. In that case the intruder may use an identification database, say a voter list, to re-identify the individuals. The intruder does not need to know which records were re-identified incorrectly because the incremental cost of including an individual in the marketing campaign is low. As long as the expected number of correct re-identifications is sufficiently high, that would provide an adequate return to the intruder. A data custodian, knowing that a marketing potential exists, would estimate marketer risk and may adjust it down to create a disincentive for such linking.

A second scenario is when a data custodian, such as a registry, is disclosing data to multiple parties. For example, the registry may disclose a data set A with ethnicity and socioeconomic indicators to a researcher and a data set B with mental health information to another researcher. Both data sets share the same core demographics on the patients. The registry would not release both ethnicity and socioeconomic, as well as mental health data to the same researcher because of the sensitivity of the data and the potential for group harm, but would do so to different researchers. However, the two researchers may collude and link A and B against the wishes of the registry. Before disclosing the data, the registry managers can evaluate the marketer risk to assess the expected number of records that can be correctly matched on the common demographics if the researchers colluded in linking data, and adjust the granularity of core demographics to make such linking unfruitful.

Consider a third scenario where a hospital has a list of all patients who have presented to emergency, D′. This data is then de-identified and sent to a municipal public health unit as D to provide general situational awareness for syndromic surveillance. The data set does not contain any unique identifiers. But a breach occurs at the public health unit and say 10% of the records, U, are exposed to an intruder. The public health unit is compelled by law to notify these patients that their data has been breached. Because D is de-identified, the public health unit would have to re-identify the patients first before notifying them, with the help of the hospital or at its own expense. The more patients that are notified the greater the cost for the public health unit and possibly also increases compensation costs. The simplest thing to do, and the most expensive one, is to work with the hospital to notify all of the patients in D′. However, the public health unit can use U to estimate \hat{λ} and determine whether matching the breached subset with the original data D′ from the hospital would yield a sufficiently high success rate. If \hat{λ} is high then the public health unit would request linking U to D′ and only notify the re-identified patients, which would be the most cost effective option that would be compliant with the legal notification requirement. If \hat{λ} is low then all patients in D′, whether included in the breached subset or not, would be notified even though 90% of them were not affected by the breach.

As a final scenario, detailed identity information can be useful for committing financial fraud and medical identity theft. However, individual records are not worth much to an intruder. In the underground economy, the rate for the basic demographics of a Canadian has been estimated to be $50. Another study determined that full-identities are worth $1-$15. Symantec has published an on-line calculator to determine the worth of an individual record, and it is generally quite low. Furthermore, there is evidence that a market for individual identifiable medical records exists. This kind of identifiable health information can also be monetized through extortion, as demonstrated recently with hackers requesting large ransoms. In one case, where the ransom amount is known, the value per patient's health information is $1.20. Given the low value of individual records, a disclosed database would only be worthwhile to such an intruder if a large number of records can be re-identified. If the marketer risk value is small, then there would be less incentive for a financially motivated intruder to attempt re-identification.

Although the above discloses example methods, apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods and apparatus, persons having ordinary skill in the art will readily appreciate that the examples provided are not the only way to implement such methods and apparatus.

### CROSS REFERENCE TO RELATED APPLICATIONS

U.S. provisional patent application Ser. No. 61/315,739, filed on Mar. 19, 2010, is incorporated herein by reference, and priority of such application is hereby claimed.

What is claimed is:

1. A method of assessing re-identification risk of a dataset containing personal information, the method executed by a processor comprising:
retrieving the dataset comprising a plurality of records from a storage device;
receiving variables selected from a plurality of variables present in the dataset, wherein the variables may be used as potential identifiers of personal information from the dataset; and
determining equivalence classes for each of the selected variables in the dataset and one or more equivalence class sizes;
determining a re-identification risk metric associated with the dataset using a modified log-linear model by measuring a goodness of fit measure generalized for each of the one or more equivalence class sizes.

2. The method according to claim 1, wherein determining a re-identification risk metric using a modified log-linear model comprises:
for the one or more equivalence classes:
determining the goodness of fit measure for the size of the equivalence class; and
determining a portion of a re-identification risk associated with the size of the equivalence class; and
determining the re-identification risk by summing all the determined portion of the re-identification risk.

3. The method according to claim 2, wherein determining the portion of the re-identification risk comprises:
calculating
$${h}^{k} ( {γ}_{j} ) = {\sum }_{{f}_{j} = k} ( \frac{k / {F}_{j}}{N} )$$
where h^{k} is the portion of the re-identification risk associated with equivalence class size k, γⱼ is the actual re-identification risk, Fⱼ is the equivalence class sizes in an identification database, N is the set of records in the identification database.

4. The method according to claim 2, wherein the goodness of fit measures a bias arising from difference between an estimated re-identification risk and an actual re-identification risk.

5. The method according to claim 4, wherein measuring the bias comprises:
calculating
$${B}_{k} = {\sum }_{j} E ( I ( {f}_{j} = k ) ) [ {h}^{k} ( {{γ}^{⋒}}_{j} ) - {h}^{k} ( {γ}_{j} ) ]$$
where Bₖ is the goodness of fit measure for equivalence class size k, ƒⱼ is the equivalence sizes in the de-identified dataset, and \hat{λ}ⱼ is the estimated re-identification risk.

6. The method according to claim 2, wherein the risk threshold selected is less than
$${R}_{J} = 1 / {min}_{j} ( {F}_{j} )$$
where R_{J} is journalist risk.

7. The method of claim 2 further comprising:
receiving a re-identification risk threshold value acceptable for the dataset; and
comparing the re-identification risk metric meets the risk threshold value.

8. The method according to claim 7, wherein if the re-identification metric is greater than the risk threshold the further comprising:
performing de-identification of the retrieved dataset based upon one or more equivalence classes to achieve the selected risk threshold.

9. The method according to claim 8 wherein if the re-identification risk metric exceeds the selected risk threshold, the method repeats by performing de-identification of the retrieved dataset with increased suppression or generalization or both to meet the selected risk threshold.

10. The method according to claim 1, wherein a source database is equivalent to an identification database.

11. The method according to claim 1, wherein the de-identified dataset is a sample of the source database that has been de-identified.

12. A system for assessing re-identification risk of a dataset containing personal information, the system comprising:
a memory;
a processor coupled to the memory, the processor performing:
retrieving the dataset comprising a plurality of records from the memory;
receiving variables selected from a plurality of variables present in the dataset, wherein the variables may be used as potential identifiers of personal information from the dataset; and
determining equivalence classes for each of the selected variables in the dataset and one or more equivalence class sizes;
determining a re-identification risk metric associated with the dataset using a modified log-linear model by measuring a goodness of fit measure generalized for each of the one or more equivalence class sizes.

13. A computer readable memory containing instructions for assessing re-identification risk of a dataset containing personal information, the instructions when executed by a processor performing:
retrieving the dataset comprising a plurality of records from the memory;
receiving variables selected from a plurality of variables present in the dataset, wherein the variables may be used as potential identifiers of personal information from the dataset; and
determining equivalence classes for each of the selected variables in the dataset and one or more equivalence class sizes;
determining a re-identification risk metric associated with the dataset using a modified log-linear model by measuring a goodness of fit measure generalized for each of the one or more equivalence class sizes.

14. The computer readable memory according to claim 13, wherein determining a re-identification risk metric using a modified log-linear model comprises:
for the one or more equivalence classes:
determining the goodness of fit measure for the size of the equivalence class; and
determining a portion of a re-identification risk associated with the size of the equivalence class; and
determining the re-identification risk by summing all the determined portion of the re-identification risk.

15. The computer readable memory according to claim 14 wherein determining the portion of the re-identification risk comprises:
calculating
$${h}^{k} ( {γ}_{j} ) = {\sum }_{{f}_{j} = k} ( \frac{k / {F}_{j}}{N} )$$
where h^{k} is the portion of the re-identification risk associated with equivalence class size k, γⱼ is the actual re-identification risk, Fⱼ is the equivalence class sizes in an identification database, N is the set of records in the identification database.

16. The computer readable memory according to claim 14, wherein the goodness of fit measures a bias arising from difference between an estimated re-identification risk and an actual re-identification risk.

17. The computer readable memory according to claim 16, wherein measuring the bias comprises:
calculating
$${B}_{k} = {\sum }_{j} E ( I ( {f}_{j} = k ) ) [ {h}^{k} ( {{γ}^{⋒}}_{j} ) - {h}^{k} ( {γ}_{j} ) ]$$
where Bₖ is the goodness of fit measure for equivalence class size k, ƒⱼ is the equivalence sizes in the de-identified dataset, and \hat{λ}ⱼ is the estimated re-identification risk.

18. The computer readable memory according to claim 14, wherein the risk threshold selected is less than
$${R}_{J} = \frac{1}{{min}_{j} ( {F}_{j} )}$$
where R_{J} is journalist risk.

19. The computer readable memory of claim 14 further comprising:
receiving a re-identification risk threshold value acceptable for the dataset; and
comparing the re-identification risk metric meets the risk threshold value.

20. The computer readable memory according to claim 19, wherein if the re-identification metric is greater than the risk threshold the further comprising:
performing de-identification of the retrieved dataset based upon one or more equivalence classes to achieve the selected risk threshold.

21. The computer readable memory according to claim 20 wherein if the re-identification risk metric exceeds the selected risk threshold, the method repeats by performing de-identification of the retrieved dataset with increased suppression or generalization or both to meet the selected risk threshold.
